(19) United States
(12) Patent Application Publication
(10) Pub. No.: US 2024/0342806 A1
(43) Pub. Date: Oct. 17, 2024

(54) WORKPIECE MEASUREMENT METHOD IN MACHINE TOOL AND MACHINE TOOL

(71) Applicant: DMG MORI CO,. LTD., Nara (JP)

(72) Inventor: Hideki NAGASUE, Nara (JP)

(73) Assignee: DMG MORI CO,. LTD., Nara (JP)

(21) Appl. No.: 18/626,899

(22) Filed: Apr. 4, 2024

(30) Foreign Application Priority Data
Apr. 4, 2023 (JP) 2023-060567

(51) Int. Cl. B23B 25/06; B25J 11/00; G01B 5/012; G01B 5/12; G06T 7/00; H04N 23/695

(52) U.S. Cl. CPC B23B 25/06; B25J 11/00; G01B 5/012; G01B 5/12; G06T 7/0004; G06T 2207/30164; H04N 23/695

(57) ABSTRACT

A measurement method uses a measurement device including a probe to measure a workpiece machined by a machine tool. The method measures the workpiece by moving the probe into contact with the workpiece in a state where the workpiece is held by the machine tool, and the method includes an image capture step (S22) of capturing an image of a portion to be measured of the workpiece with a camera and a determination step (S23) of processing the image captured with the camera and determining whether or not a chip is present on a movement path along which the probe is to be moved. The measurement of the workpiece using the probe is executed when no chip is present on the movement path of the probe in the determination step (S23).

### TECHNICAL FIELD

The present invention relates to a measurement method in which a workpiece machined by a machine tool is measured in a state of being held by the machine tool, in other words, measured inside the machine tool, and also relates to a machine tool capable of executing the measurement method.

### BACKGROUND ART

Japanese Unexamined Patent Application Publication No. 2014-237204 discloses a conventionally known method for measurement of a dimension of a workpiece machined by a machine tool executed inside the machine tool. This method is such that, after a workpiece held by a chuck on a spindle is machined using a tool mounted on a turret in an NC lathe, a dimension, e.g., an outer diameter or a hole inside diameter, of the workpiece is measured by bringing a touch probe mounted on the turret into contact with the portion to be measured of the workpiece and reading a scale at the time when contact of the touch probe with the portion to be measured is detected.

However, the dimension of the portion to be measured of the workpiece is not accurately measured if any chip produced during machining adheres to the portion to be measured. Accordingly, measures have conventionally been taken to clean the portion to be measured of the workpiece before the measurement, such as spraying coolant on the portion to be measured of the workpiece to wash away chips or blowing compressed air toward the portion to be measured of the workpiece to blow off chips.

### SUMMARY OF INVENTION

Depending on the workpiece material or the machining conditions, a chip curled in a spiral shape may be produced. For example, in drilling, a curled chip produced may be caught in a hole of the workpiece and may therefore not be discharged to the outside. In most cases, such a chip caught in a hole of the workpiece is not easily discharged to the outside by spraying coolant, blowing compressed air, or the like.

A chip remaining in a hole of the workpiece not only results in inaccurate measurement of a dimension, such as a hole inside diameter, of the workpiece but also may result in the touch probe being damaged by coming into contact with the chip when being inserted into the hole.

The present invention has been achieved in view of the above-described circumstances, and an object of the invention is to provide a measurement method which allows a workpiece machined by a machine tool and held by the machine tool to be measured in a state where chips have been removed from the portion to be measured of the workpiece.

To solve the above-described, the present invention provides a measurement method that uses a measurement device including a probe to measure a workpiece machined by a machine tool and measures the workpiece by moving the probe into contact with the workpiece in a state where the workpiece is held by the machine tool and that includes:
an image capture step of capturing an image of a portion to be measured of the workpiece with a camera; and
a determination step of processing the image captured with the camera and determining whether or not a chip is present on a movement path along which the probe is to be moved,
wherein the measurement of the workpiece using the probe is executed when no chip is present on the movement path of the probe in the determination step.

In the measurement method according to the present invention, an image of the portion to be measured of the workpiece is first captured with a camera in the image capture step. For example, where the portion to be measured is an outer periphery of the workpiece, an image of the outer periphery is captured with a camera. Where the portion to be measured is a hole of the workpiece, an image of the hole is captured with a camera.

Subsequently, in the determination step, the image captured with the camera is processed and it is determined whether or not a chip is present on the movement path of the probe. For example, the image is processed by the image binarization, so that the presence or absence of a chip is determined by obtaining a difference between the current binarized image and a previously obtained binarized reference image including no chip.

When it is determined in the determination step that no chip is present on the movement path of the probe, the measurement of the workpiece using the probe is executed. Note that, when a chip is present in the image in the image processing but the chip is not present on the movement path of the probe, that is to say, when the probe is not to interfere with the chip during the movement, it is determined that no chip is present on the movement path of the probe; consequently, the measurement of the workpiece using the probe is executed. A typical and specific example case is as follows: when the presence of a chip is observed on a portion other than a hole as the portion to be measured of the workpiece in the image but no chip is present in the hole, it is determined that no chip is present on the movement path of the probe.

Thus, the measurement method according to the present invention is configured such that the measurement of the workpiece using the probe is executed only when no chip is present on the movement path of the probe. Therefore, the workpiece, for example, a dimension of the workpiece, is accurately measured and the probe is reliably prevented from being damaged by coming into contact with a chip.

The measurement method according to the present invention may be configured according to the following aspect:
the method further includes a removal step of, when it is determined in the determination step that a chip is present on the movement path of the probe, removing the chip from the movement path;
the image capture step and the determination step are re-executed after the removal step is executed;
when it is determined in the re-executed determination step that no chip is present on the movement path of the probe, the measurement of the workpiece using the probe is executed; and
when it is determined in the re-executed determination step that a chip is present on the movement path of the probe, the measurement of the workpiece using the probe is halted.

In this aspect, when it is determined in the determination step that a chip is present on the movement path of the probe, the removal step of removing the chip from the movement path is executed and the image capture step and the determination step are re-executed after the execution of the removal step. When it is determined in the re-executed determination step that no chip is present on the movement path of the probe, the measurement of the workpiece using the probe is executed. On the other hand, when it is determined in the re-executed determination step that a chip is present on the movement path of the probe, the measurement of the workpiece using the probe is halted.

Thus, the measurement method according to this aspect is configured such that, when a chip is present on the movement path of the probe, the removal step of removing the chip from the movement path is executed. This prevents the workpiece from being classified as a pending product in a single determination process, so that the yield of workpieces is enhanced.

In the image capture step, a camera provided on a movable body of the machine tool may be used. In this case, the image capture step may be configured such that the camera is moved to an image capture position by the movable body to capture an image of the portion to be measured of the workpiece.

Alternatively, in the image capture step, a camera provided on a manipulator configured to attach and remove the workpiece to and from a workpiece holding unit of the machine tool may be used. In this case, the image capture step may be configured such that the camera is moved to an image capture position by operation of the manipulator to capture an image of the portion to be measured of the workpiece. The manipulator may be provided to be capable of autonomously traveling.

The present invention further provides a machine tool that machines a workpiece and that includes a controller and is capable of, under control by the controller, measuring the workpiece after machining by moving a probe into contact with the workpiece while holding the workpiece, wherein
the controller is configured to:
   capture an image of a portion to be measured of the workpiece after machining with a camera provided on the machine tool by operating the camera, and issue an instruction (execution instruction) for execution of a process of processing the captured image and determining whether or not a chip is present on a movement path along which the probe is to be moved (determination process), or
   cause a camera provided on an external device to capture an image of the portion to be measured of the workpiece after machining (image capture process), and issue an instruction (execution instruction) for execution of a process of processing the captured image and determining whether or not a chip is present on the movement path along which the probe is to be moved (determination process); and
   when no chip is present on the movement path of the probe, measure the workpiece by moving the probe.

Note that the workpiece after machining means a workpiece that has been subjected to machining (including removal machining and additive machining) by the machine tool in a state of being installed in (held by) the machine tool and remains held by the machine tool without being removed from the machine tool after the machining. An image of the workpiece in this state is captured with or by the camera.

As described above, the controller can cause an external device to execute the image capture process. In this case, the controller issues an execution instruction to the external device by transmitting an instruction signal, such as an image capture start signal, to the external device. In this case, the controller further can cause the external device or any other device to execute the determination process based on the captured image. In this case, the controller issues an execution instruction to the external device or the other device by transmitting an instruction signal, such as a process start signal, to the external device or the other device. Alternatively, the controller can execute the determination process by itself. Also in this case, the controller issues an execution instruction to an internal processing unit by transmitting an instruction signal, such as a process start signal, to the internal processing unit.

### Advantageous Effects of Invention

The measurement method according to the present invention is configured such that the measurement of the workpiece using the probe is executed only when no chip is present on the movement path of the probe. Therefore, the workpiece is accurately measured and the probe is reliably prevented from being damaged by coming into contact with a chip.

### BRIEF DESCRIPTION OF DRAWINGS

FIG. 1 is an illustrative diagram schematically illustrating a configuration of a production system according to a first embodiment of the present invention;

FIG. 2 is a plan view illustrating a device arrangement in the production system according to the first embodiment;

FIG. 3 is a perspective view of an automatic working device in the first embodiment;

FIG. 4 is a flowchart showing a procedure of a measurement process in the first embodiment;

FIG. 5 is an illustrative diagram illustrating a check operation to be executed by the automatic working device in the first embodiment;

FIG. 6 is an illustrative diagram for explaining the measurement process in the first embodiment;

FIG. 7 is an illustrative diagram for explaining the measurement process in the first embodiment;

FIG. 8 is an illustrative diagram for explaining a removal process in the first embodiment;

FIG. 9 is a flowchart showing a procedure of a measurement process in a variation of the first embodiment;

FIG. 10 is an illustrative diagram schematically illustrating a structure of a production system according to a second embodiment of the present invention;

FIG. 11 is a flowchart showing a procedure of a measurement process in the second embodiment;

FIG. 12 is an illustrative diagram schematically illustrating a structure of a production system according to a third embodiment of the present invention;

FIG. 13 is a flowchart showing a procedure of a measurement process in the third embodiment; and

FIG. 14 is a flowchart showing a procedure of a measurement process in a fourth embodiment of the present invention.

### DESCRIPTION OF EMBODIMENTS

Hereinafter, specific embodiments of the present invention will be described with reference to the drawings.

### First Embodiment

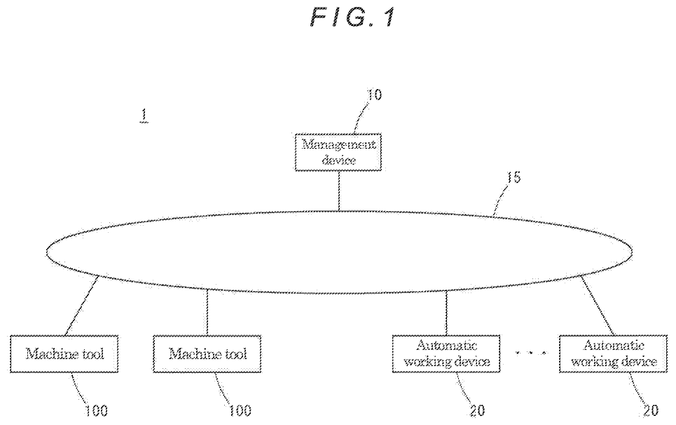

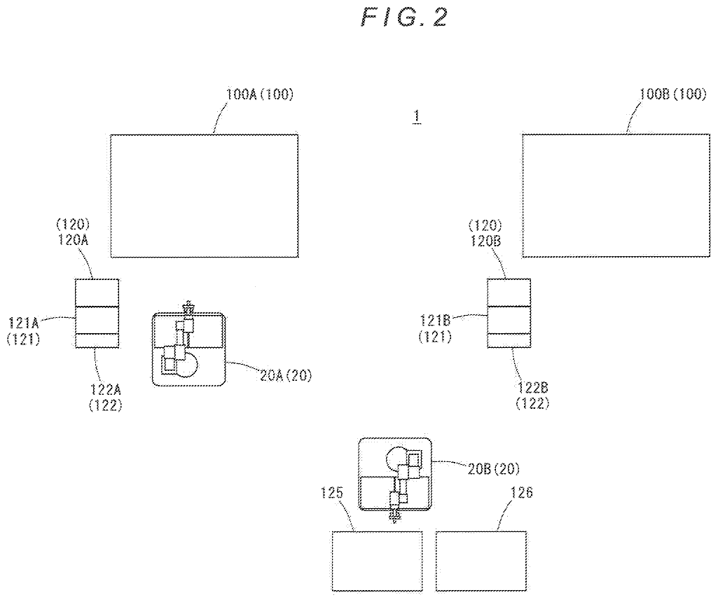

Firstly, a first embodiment of the present invention is described. As illustrated in FIGS. 1 and 2, a production system 1 according to this embodiment includes two machine tools 100 (100A and 100B) as production devices, a material stocker 125, a product stocker 126, two automatic working devices 20 (20A and 20B), and a management device 10. The material stocker 125 is used to store unmachined materials. The product stocker 126 is used to store machined products. The two automatic working devices 20 perform work on the machine tools 100, the material stocker 125, and the product stocker 126. The management device 10 manages the operations of the machine tools 100 and automatic working devices 20 by issuing operation instructions to the machine tools 100 and the automatic working devices 20. The management device 10, the automatic working devices 20, and the machine tools 100 are connected by wire or wirelessly to one another through an appropriate network 15. Needless to say, the configuration illustrated in FIG. 1 is just an example and the present invention is not limited to the configuration.

The machine tools 100 each can be any conventionally known machine tool having a communication function for connecting to the network 15, such as an NC lathe or a machining center. In this embodiment, the machine tools 100 (100A and 100B) are each an NC lathe. By way of example, the two machine tools 100A and 100B are arranged side by side with an appropriate interval therebetween as illustrated in FIG. 2. As a matter of course, the number of machine tools 100 to be provided and the arrangement of the machine tools 100 are not limited thereto.

In the vicinity of each machine tool 100 (100A, 100B), a material stocker 120 (120A, 120B) for storing materials, a product stocker 121 (121A, 121B) for storing products, and a pending product stocker 122 (122A, 122B) for storing pending products including defective products are arranged. Note that the above-mentioned material stocker 125 and product stocker 126 each have a larger capacity than the material stockers 120 and the product stockers 121 and are disposed away from the machine tools 100.

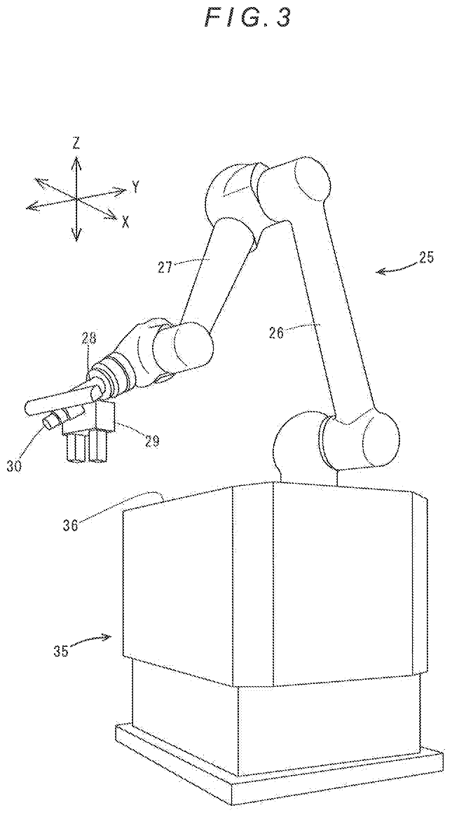

As illustrated in FIG. 3, each automatic working device 20 is constituted by an automated guided vehicle 35, a robot 25 mounted on the automated guided vehicle 35, a controller controlling the automated guided vehicle 35 and the robot 25, and other elements.

The robot 25 is mounted on a mount surface 36 as a top surface of the automated guided vehicle 35. The automated guided vehicle 35 has a sensor (for example, a distance measurement sensor using a laser beam) for enabling recognition of the position of the automated guided vehicle 35 in a factory. The automated guided vehicle 35 is configured to travel tracklessly in the factory, including the area where the machine tools 100 and other elements are disposed, under control by the controller. In this embodiment, the automated guided vehicle 35 is configured to move to working positions respectively set with respect to the machine tools 100, the material stocker 125, and the product stocker 126. In this embodiment, the controller is provided in the automated guided vehicle 35.

The robot 25 is an articulated robot that has three arms, namely, a first arm 26, a second arm 27, and a third arm 28, as a manipulator unit. The first arm 26, the second arm 27, and the third arm 28 are successively connected by joints. The third arm 28 has a hand 29 and a camera 30 as end effectors attached to the distal end thereof. The robot 25 moves the hand 29 and the camera 30 in a three-dimensional space under control by the controller. Note that the robot 25 is not limited to such an articulated structure and can have any available known structure.

The controller of each automatic working device 20 is connected to the automated guided vehicle 35 and robot 25 of the automatic working device 20 and is connected to the management device 10, a controller of each machine tool 100, and the controller of the other automatic working device 20 through the network 15. Note that the management device 10, the controllers of the machine tools 100, and the controllers of the automatic working devices 20 are each composed of a computer including a CPU, a RAM, and a ROM.

The management device 10 connects to the controller of each machine tool 100 and the controller of each automatic working device 20 through the network 15 and functions to manage the operational status of each machine tool 100 and the operational status of each automatic working device 20 in accordance with a predetermined machining schedule. For example, in accordance with a predetermined machining schedule, the management device 10 issues an operation instruction to each machine tool 100 and each automatic working device 20 to perform an operation. Specifically, in accordance with the machining schedule, the management device 10 instructs a predetermined machine tool 100 to machine a predetermined product and instructs a predetermined automatic working device 20 to perform a removal and attachment operation of removing a machined product from the machine tool 100 and attaching a new material to the machine tool 100. Thus, the management device 10 manages machining in each machine tool 100.

The removal and attachment operation is performed as follows: a machined product is first removed from the inside of the machine tool 100; when the machined product is a non-defective product, the machined product is stored into the product stocker 121; when the machined product is a pending product, the machined product is stored into the pending product stocker 122; and thereafter a material is taken out from the material stocker 120 and supplied to the machine tool 100. In this embodiment, the automatic working device 20 moves to the working position set with respect to the machine tool 100 to perform this removal and attachment operation.

Further, in accordance with the machining schedule, the management device 10 instructs a predetermined automatic working device 20 to perform a material supply operation and a product collection operation. The material supply operation is an operation of taking out materials stored in the material stocker 125 from the material stocker 125 and supplying the materials to the material stockers 120 for the machine tools 100. The product collection operation is an operation of taking out products stored in the product stockers 121 for the machine tools 100 and collecting the products into the product stocker 126. In the material supply operation and the product collection operation, the automatic working device 20 moves between the material stockers 120 and product stockers 121 for the machine tools 100 and the material stocker 125 and product stocker 126. The products stored in the pending product stockers 122 are each checked for condition by an operator and then appropriately collected.

The positioning errors of each automatic working device 20 with respect to each machine tool 100, the material stocker 125, and the product stocker 126 are detected, for example, by capturing an image of an identification figure, which is provided on each machine tool 100, with the camera 30 provided on the automatic working device 20 and analyzing the captured image in the controller of the automatic working device 20. Based on the detected positioning errors of the automatic working device 20, the operating poses of the robot 25 operating under control by the controller in each of the above-described operations, i.e., the removal and attachment operation, the material supply operation, and the product collection operation, are corrected.

In each machine tool 100 in this embodiment, after completion of machining of a product (workpiece), in-machine measurement is carried out in which a dimension of the machined product (workpiece) is measured inside the machine tool 100, in other words, measured in a state where the machined product (workpiece) remains held by the machine tool 100 without being removed. The in-machine measurement can be performed in a conventionally known manner. For example, the in-machine measurement is performed as follows: a touch probe 110 as a measurement probe as illustrated in FIG. 7 is attached to a tool spindle or a turret; the tool spindle or the turret is moved under control by the controller of the machine tool 100 to bring the touch probe 110 into contact with a portion to be measured of the machined product (workpiece W); and the dimension of the portion to be measured is calculated in the controller of the machine tool 100 on the basis of reading of a scale at the time of the contact. Hereinafter, unless otherwise indicated, the machined product is referred to as “workpiece W”. Note that the scale is provided along the movement axis for the tool spindle or the movement axis for the turret. The dimension to be measured is, for example, an outer diameter dimension or an inner diameter dimension of the workpiece W.

The dimension of the workpiece W is not accurately measured if a chip produced during the machining adheres to the workpiece W. Accordingly, a cleaning process has conventionally been carried out before the measurement. In the cleaning process, coolant is sprayed on the workpiece W to wash away chips and then compressed air is blown toward the workpiece W to blow off coolant and chips adhering to the workpiece W. A chip adhering to the outer surface of the workpiece W is relatively easily removed by the cleaning process. However, a chip remaining in a hole of the workpiece W may not be removed by the cleaning process. It is particularly difficult to remove a curled chip from a hole of the workpiece W. Further, a curled chip remaining in the hole not only results in inaccurate measurement but also, in some cases, may result in the touch probe 110 being damaged by coming into contact with the curled chip.

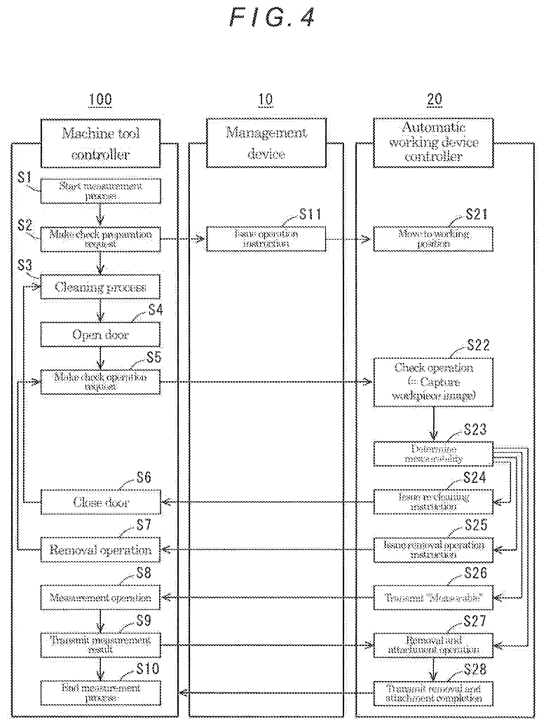

Accordingly, in this embodiment, an image of the portion to be measured of the workpiece W is captured with the camera 30 provided on the automatic working device 20, and the captured image is analyzed and it is checked whether or not a chip adheres to the portion to be measured. Hereinafter, a specific procedure of the in-machine measurement in this embodiment is described on the basis of FIG. 4. In FIG. 4, the processes are executed in the controller of the machine tool 100, the controller of the automatic working device 20, and the management device 10; however, in the following description, for the sake of simplicity, the machine tool 100 inclusive of the controller thereof is simply referred to as the machine tool 100 and the automatic working device 20 inclusive of the controller thereof is simply referred to as the automatic working device 20.

As shown in FIG. 4, upon completing machining of a workpiece W, the machine tool 100 subsequently starts the measurement process (step S1). The machine tool 100 first makes a check preparation request (transmits an execution signal) to the management device 10 through the network 15 (step S2), and then executes the cleaning process (step S3). Upon receiving the check preparation request, the management device 10 recognizes an available automatic working device 20, and then issues an operation instruction for a check operation (measurement assistance operation) to the recognized automatic working device 20 (step S11). Upon receiving the operation instruction, the automatic working device 20 moves to the working position set with respect to the machine tool 100 as the operation target (step S21), and then executes the measurement assistance operation and the removal and attachment operation, which are described later.

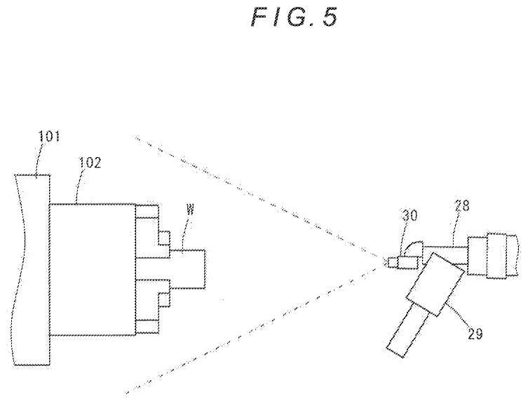

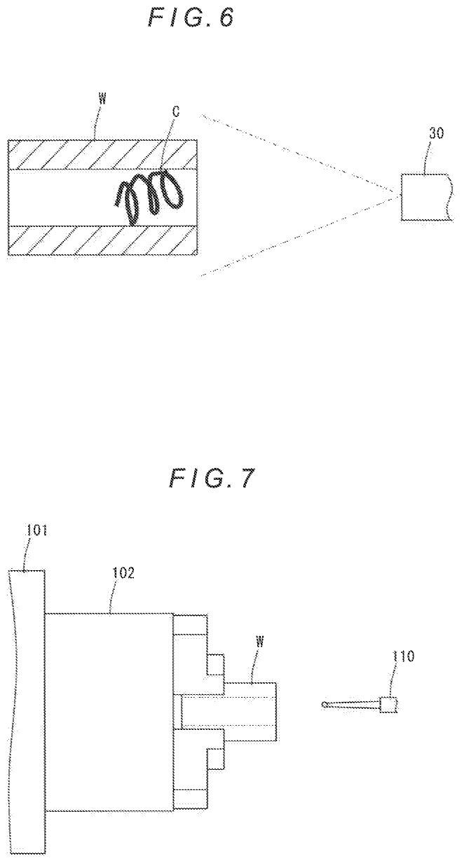

On the other hand, upon completing the cleaning process, the machine tool 100 opens a door separating the machining area from the outside (step S4). Thereafter, the machine tool 100 makes a request (transmits an execution signal) to the associated automatic working device 20 through the network 15 to execute the check operation (step S5). Upon receiving the request, the automatic working device 20 executes the check operation (step S22). Specifically, the automatic working device 20 operates the robot 25 to cause the robot 25 to move the camera 30 into the machining area of the machine tool 100 as shown in FIG. 5, then brings the robot 25 into a pose for capturing an image of the portion to be measured of the workpiece W, and then captures an image of the workpiece W with the camera 30 as shown in FIG. 6 (image capture step). In FIG. 5, the reference numeral 101 denotes a spindle of the machine tool 100 and the reference numeral 102 denotes a chuck clamping the workpiece W. In FIG. 6, the reference symbol C denotes a chip that has a curled shape and is caught in a hole of the workpiece W.

Subsequently, the automatic working device 20 analyzes the captured image and determines whether or not a chip is present on the path along which the touch probe 110 is to be moved, in other words, whether or not the workpiece W is measurable (step S23) (determination step). Needless to say, the measurement cannot be executed when a chip is present on the movement path, while the measurement can be executed when no chip is present on the movement path. Note that the image is analyzed, for example, by the image binarization, so that the presence or absence of a chip is determined by obtaining a difference between the current binarized image and a previously obtained binarized image as a reference (reference image) including no chip. In the above-described image analysis, when a chip is present in the image but the chip is located on the movement path of the touch probe 110, that is to say, when the touch probe 110 is not to interfere with the chip during the movement, it is determined that no chip is present on the movement path of the touch probe 110. A typical and specific example case is as follows: when the presence of a chip is observed on a portion other than a hole as the portion to be measured of the workpiece W in the image but no chip is present in the hole, it is determined that no chip is present on the movement path of the touch probe 110.

The automatic working device 20 evaluates the image analysis result, for example, as one of the following four states:
(a) Measurable (when no chip is present);
(b) Re-cleaning required (when adhesion of a chip is observed on a portion of the movement path, e.g., when the presence of a chip is observed in a portion of the hole);
(c) Removal required (when the presence of a chip is observed throughout the movement path, e.g., when the presence of a chip is observed in the entire hole); and
(d) Unmeasurable (when the presence of a chip is still observed on the movement path even after a re-cleaning process or a removal operation, which are described later, is executed).

When the evaluation result is the “Re-cleaning required” state, the automatic working device 20 subsequently instructs the machine tool 100 to execute a re-cleaning process (step S24). When the evaluation result is the “Removal required” state, the automatic working device 20 subsequently instructs the machine tool 100 to execute a removal operation (step S25). When the evaluation result is the “Measurable” state, the automatic working device 20 transmits a “Measurable” signal to the machine tool 100 (step S26). When the evaluation result is the “Unmeasurable” state that indicates that the presence of a chip is still observed on the movement path even after the removal process (removal step), i.e., the re-cleaning process or the removal operation, is executed, the automatic working device 20 removes the workpiece W from the machine tool 100 and stores the workpiece W into the pending product stocker 122. Subsequently, the automatic working device 20 takes out a new material from the material stocker 120 and causes the material to be clamped by the chuck 102 of the machine tool 100 (step S27). Thereafter, the automatic working device 20 transmits a removal and attachment completion signal to the machine tool 100 (step S28).

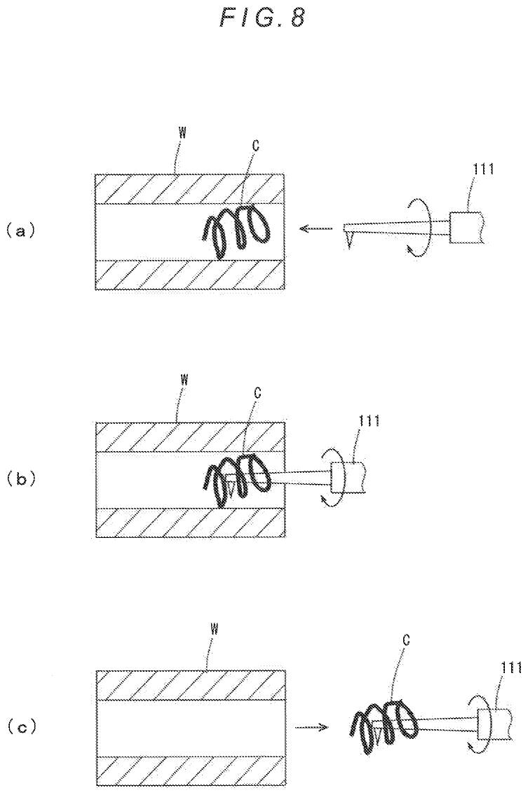

Upon receiving the re-cleaning instruction from the automatic working device 20, the machine tool 100 closes the door (step S6) and re-executes the above-described cleaning process (step S3), and then performs the operations in the step S4 and subsequent steps. Upon receiving the removal instruction from the automatic working device 20, the machine tool 100 executes the removal operation (step S7), and then re-performs the operation in the step S5. For example, the removal operation can be performed as shown in FIG. 8, that is to say, by rotating a removal tool 111 attached to the turret or the tool spindle (FIG. 8(a)), inserting the rotating removal tool 111 into the hole of the workpiece W (FIG. 8(b)), catching the chip C on a hook-shaped portion provided at the tip of the removal tool 111, and then retracting the removal tool 111 from the hole (FIG. 8(c)). Note that the removal tool 111 and the removal operation are just an example and the present invention is not limited thereto.

Upon receiving the “Measurable” signal from the automatic working device 20, the machine tool 100 executes the above-described measurement operation using the touch probe 110 (step S8). Thereafter, the machine tool 100 transmits the measurement result to the automatic working device 20 (step S9) and ends the measurement process (step S10). Note that the machine tool 100 is capable of correcting a machining error in accordance with the measurement result in machining the next workpiece.

After receiving the measurement result from the machine tool 100, the automatic working device 20 removes the workpiece W from the machine tool 100. When the workpiece W is a non-defective product, the automatic working device 20 stores the workpiece W into the product stocker 121. When the workpiece W is a defective product, the automatic working device 20 stores the workpiece W into the pending product stocker 122. Subsequently, the automatic working device 20 takes out a new material from the material stocker 120 and causes the material to be clamped by the chuck 102 of the machine tool 100 (step S27). Thereafter, the automatic working device 20 transmits the removal and attachment completion signal to the machine tool 100 (step S28).

Upon receiving the removal and attachment completion signal transmitted from the automatic working device 20 in the operation in the step S28, the machine tool 100 machines the next workpiece. Upon completing the machining, the machine tool 100 executes the measurement process, that is to say, performs the operations in the step S1 and subsequent steps.

As described above, the in-machine measurement method according to this embodiment is configured such that: an image of the portion to be measured of the machined workpiece W is captured with the camera 30 that is provided on the automatic working device 20; the captured image is analyzed and it is thereby determined whether or not a chip is present on the portion to be measured, in other words, whether or not a chip is present on the movement path of the touch probe 110; and the dimension measurement of the workpiece W using the touch probe 110 is executed only when it is determined that no chip is present on the movement path. Therefore, the dimension of the workpiece W is accurately measured and the touch probe 110 is reliably prevented from being damaged by coming into contact with a chip.

In this embodiment, when it is determined in the determination step at the step S23 that a chip is present on the movement path of the touch probe 110, the machine tool 100 executes the removal step of removing the chip present on the movement path, that is to say, executes the re-cleaning process (step S3) or the removal operation (step S7). This prevents the workpiece W from being determined to be unmeasurable and classified as a pending product in a single check operation (determination process), so that high-yield measurement is realized.

### Variation 1 of First Embodiment

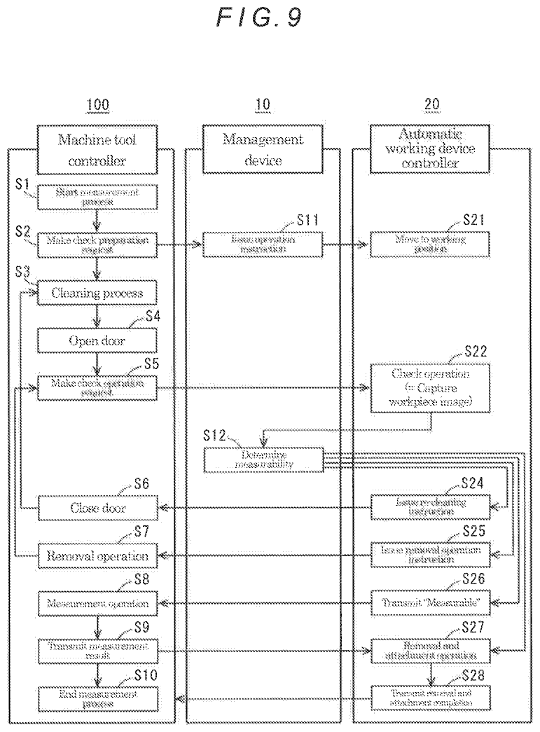

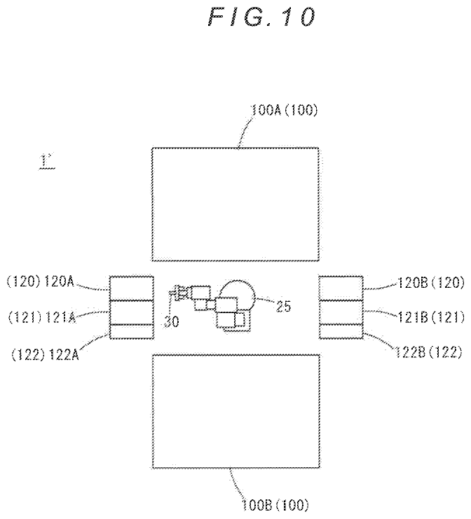

In the above-described embodiment, the measurability determination in the step S23 is executed in the automatic working device 20. However, the present invention is not limited thereto. For example, as shown in FIG. 9, the measurability determination in the step S23 may be executed in the management device 10 by transmitting data on the image of the workpiece W captured with the camera 30 of the automatic working device 20 in the step S22 to the management device 10. The configuration in which the measurability determination in the step S23 is executed in the controller of the automatic working device 20 requires the controller of the automatic working device 20 to be composed of a computer having a high processing capability. Consequently, the automatic working device 20 is large in size and therefore has an impaired mobility. The configuration in which the measurability determination in the step S23 is executed in the management device 10 prevents the controller of the automatic working device 20 from being excessively large in size; therefore, the automatic working device 20 is prevented from being impaired in mobility and can be configured to have an appropriate mobility.

Note that the processes in FIG. 9 are also executed in the controller of the machine tool 100, the controller of the automatic working device 20, and the management device 10. Note that the measurability determination in the step S12 may be executed in the management device 10 by transmitting a process start signal (instruction signal) to the management device 10 from the controller of the machine tool 100. Further, the operations in the steps S24 to S26 in the automatic working device 20 may be executed in the management device 10. Alternatively, the measurability determination and the operations in the steps S24 to S26 may be executed by a device other than the controller of the automatic working device 20 and the management device 10.

### Variation 2 of First Embodiment

In the examples shown in FIGS. 4 and 9, the machine tool 100 makes the check preparation request to the automatic working device 20 through the management device 10. However, the present invention is not limited thereto. The machine tool 100 may make the check preparation request directly to the automatic working device 20. In this case, a configuration may be employed in which the automatic working device 20 in a standby state performs work on the machine tool 100.

### Second Embodiment

Next, a second embodiment of the present invention is described. In the above-described embodiment, the image capture step and the determination step are executed by the autonomously travelable automatic working device 20 that is constituted by the robot 25 and the automated guided vehicle 35. However, the present invention is not limited thereto. As shown in FIG. 10, the above-described image capture step and determination step may be executed by a fixed robot 25. In the example shown in FIG. 10, elements identical to those in FIG. 2 are denoted by the same reference numerals as in FIG. 2 and detailed description thereof is omitted.

This embodiment employs a configuration in which two machine tools 100 (100A and 100B) are arranged to face each other with a robot 25 arranged between the machine tools 100A and 100B as shown in FIG. 10. The robot 25 in this embodiment is fixed to the floor surface instead of the mount surface 36 of the automated guided vehicle 35. Around the robot 25, a material stocker 120A, a product stocker 121A, and a pending product stocker 122A are arranged with respect to the machine tool 100A, and a material stocker 120B, a product stocker 121B, and a pending product stocker 122B are arranged with respect to the machine tool 100B.

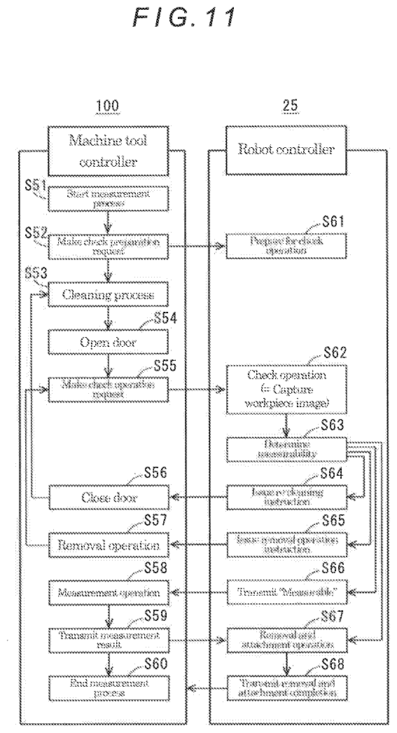

Also in this embodiment, the robot 25 executes the workpiece removal and attachment operation including the image capture step and the determination step in response to a request from each machine tool 100. The process procedure in this embodiment is shown in FIG. 11. The procedure shown in FIG. 11 is substantially identical to the procedures shown in FIGS. 4 and 9. However, the outline of the procedure shown in FIG. 11 is described here although the description overlaps the foregoing descriptions of the procedures shown in FIGS. 4 and 9. In this embodiment, the machine tool 100 includes a controller and the operation of the machine tool 100 is controlled by the controller and the robot 25 also includes a controller and the operation of the robot 25 is controlled by the controller. The processes in FIG. 11 are executed in the controller of the machine tool 100 and the controller of the robot 25; however, in the following description, for the sake of simplicity, the machine tool 100 inclusive of the controller thereof is simply referred to as the machine tool 100 and the robot 25 inclusive of the controller thereof is simply referred to as the robot 25.

As shown in FIG. 11, upon completing machining of a workpiece W, the machine tool 100 starts the measurement process (step S51). The machine tool 100 first makes a check preparation request (transmits an execution signal) to the robot 25 (step S52), and then executes the cleaning process (step S53). Upon receiving the check preparation request, the robot 25 shifts to the operating pose set with respect to the machine tool 100 as the operation target, that is to say, prepares for a check operation (step S61).

On the other hand, upon completing the cleaning process, the machine tool 100 opens the door (step S54). Thereafter, the machine tool 100 makes a request (transmits an execution signal) to the robot 25 to execute the check operation (step S55). Upon receiving this request, the robot 25 performs the check operation (step S62). Specifically, the robot 25 moves the camera 30 into the machining area of the machine tool 100, then shifts to the pose for capturing an image of the portion to be measured of the workpiece W, and then captures an image of the workpiece W with the camera 30 (image capture step).

Subsequently, the robot 25 analyzes the captured image and determines, in the same manner as described above, whether or not a chip is present on the path along which the touch probe 110 is to be moved, in other words, whether or not the workpiece W is measurable (step S63) (determination step).

When the evaluation result is the “Re-cleaning required” state, the robot 25 subsequently instructs the machine tool 100 to execute the re-cleaning process (step S64). When the evaluation result is the “Removal required” state, the robot 25 subsequently instructs the machine tool 100 to execute the removal operation (step S65). When the evaluation result is the “Measurable” state, the robot 25 transmits a “Measurable” signal to the machine tool 100 (step S66). When the evaluation result is the “Unmeasurable” state that indicates that the presence of a chip is still observed on the movement path even after the re-cleaning process or the removal operation is executed, the robot 25 removes the workpiece W from the machine tool 100 and stores the workpiece W into the pending product stocker 122. Subsequently, the robot 25 takes out a new material from the material stocker 120 and causes the material to be clamped by the chuck 102 of the machine tool 100 (step S67). Thereafter, the robot 25 transmits the removal and attachment completion signal to the machine tool 100 (step S68).

Upon receiving the re-cleaning instruction from the robot 25, the machine tool 100 closes the door (step S56) and re-executes the above-described cleaning process (step S53), and then performs the operations in the step S54 and subsequent steps. Upon receiving the removal instruction from the robot 25, the machine tool 100 executes the same removal operation as in the step S7 described above (step S57), and then re-performs the operation in the step S55.

Upon receiving the “Measurable” signal from the robot 25, the machine tool 100 executes the above-described measurement operation using the touch probe 110 (step S58). Thereafter, the machine tool 100 transmits the measurement result to the robot 25 (step S59) and ends the measurement process (step S60).

After receiving the measurement result from the machine tool 100, the robot 25 removes the workpiece W from the machine tool 100. When the workpiece W is a non-defective product, the robot 25 stores the workpiece W into the product stocker 121. When the workpiece W is a defective product, the robot 25 stores the workpiece W into the pending product stocker 122. Subsequently, the robot 25 takes out a new material from the material stocker 120 and causes the material to be clamped by the chuck 102 of the machine tool 100 (step S67). Thereafter, the robot 25 transmits the removal and attachment completion signal to the machine tool 100 (step S68).

Upon receiving the removal and attachment completion signal transmitted from the robot 25 in the operation in the step S68, the machine tool 100 machines the next workpiece. Upon completing the machining, the machine tool 100 executes the measurement process, that is to say, performs the operations in the step S51 and subsequent steps.

Thus, the method according to this embodiment is also configured such that: an image of the portion to be measured of the machined workpiece W is captured with the camera 30 that is provided on the robot 25; the captured image is analyzed and it is thereby determined whether or not a chip is present on the movement path of the touch probe 110; and the dimension measurement of the workpiece W using the touch probe 110 is executed only when it is determined that no chip is present on the movement path. Therefore, the dimension of the workpiece W is accurately measured and the touch probe 110 is reliably prevented from being damaged by coming into contact with a chip.

Further, when it is determined in the determination step at the step S63 that a chip is present on the movement path of the touch probe 110, the machine tool 100 executes the removal step of removing the chip present on the movement path, that is to say, executes the re-cleaning process (step S53) or the removal operation (step S57). This prevents the workpiece W from being determined to be unmeasurable and classified as a pending product in a single check operation (determination process), so that high-yield measurement is realized.

### Third Embodiment

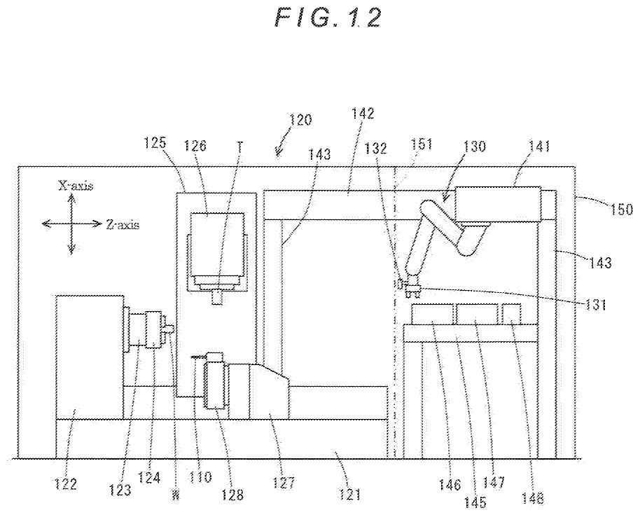

Next, a third embodiment of the present invention is described. In the above-described embodiments, the robot is provided separately from the machine tool. However, the present invention is not limited thereto. As illustrated in FIG. 12, the robot may be attached to the machine tool. In FIG. 12, the reference numeral 120 denotes a machine tool, the reference numeral 130 denotes a robot, and the reference numeral 150 denotes a cover. Also in this embodiment, the machine tool 120 includes a controller and the operation of the machine tool 120 is controlled by the controller and the robot 130 includes a controller and the operation of the robot 130 is controlled by the controller.

The machine tool 120 has a bed 121, a headstock 122, a column 125, and a tool rest 127. The headstock 122, the column 125, and the tool rest 127 are arranged on the bed 121. The headstock 122 holds a spindle 123 that is disposed horizontally and is rotatably held by the headstock 122. The spindle 123 has a chuck 124 mounted on the distal end thereof. The chuck 124 clamps a workpiece W. The tool rest 127 is provided to be movable in an X-axis direction and a Z-axis direction. The tool rest 127 has a turret 128 on a side face thereof located on the spindle 123 side. The turret 128 has appropriate tools as well as a touch probe 110 and a removal tool (a removal tool 111 similar to that in the above-described embodiments) attached thereto. The touch probe 110 and the removal tool are attached to the turret 128 so as to extend along the Z-axis direction.

The column 125 is provided to be movable in the Z-axis direction. The column 125 has a tool spindle 126 thereon that is provided to be movable in the X-axis direction. The tool spindle 126 holds a tool T in a rotatable manner.

The workpiece W is machined by appropriately moving the tool rest 127 in the X-axis and Z-axis directions with a tool, as one of the tools attached to the turret 128, indexed at the machining position. Further, the workpiece W is machined by appropriately moving the column 125 in the Z-axis direction and appropriately moving the tool spindle 126 in the X-axis direction. The measurement of the dimension of the workpiece W is performed by appropriately moving the tool rest 127 in the X-axis and Z-axis directions with the touch probe 110, which is attached to the turret 128, indexed at the machining position so as to bring the touch probe 110 into contact with the portion to be measured of the workpiece W. Further, the same removal operation as in the above-described embodiments is performed with the removal tool 111 indexed at the machining position.

The robot 130 is mounted on a lower surface of a carriage 141. The carriage 141 is engaged with a beam 142 supported horizontally along the Z-axis direction by supports 143, 143 and is provided to be movable along the beam 142. The beam 142 is disposed to extend from the inside to the outside of the machining area separated by a partition member 151. The robot 130 is reciprocated between the inside of the machining area and a standby position outside the machining area by moving the carriage 141 in the Z-axis direction. The robot 130 is a six-axis articulated robot. The robot 130 has a hand 131 and a camera 132 as end effectors provided at the distal end thereof. Note that the partition member 151 has an opening formed therein. The beam 142 is disposed to extend through this opening. The robot 130 moves in the Z-axis direction through this opening. Further, this opening is configured such that the area for the movement of the robot 130 in the Z-axis direction is able to be opened and closed by an appropriate shutter.

At the standby position outside the machining area, a placement table 145 is provided below the robot 130 and a material stocker 146, a product stocker 147, and a pending product stocker 148 are arranged on the placement table 145.

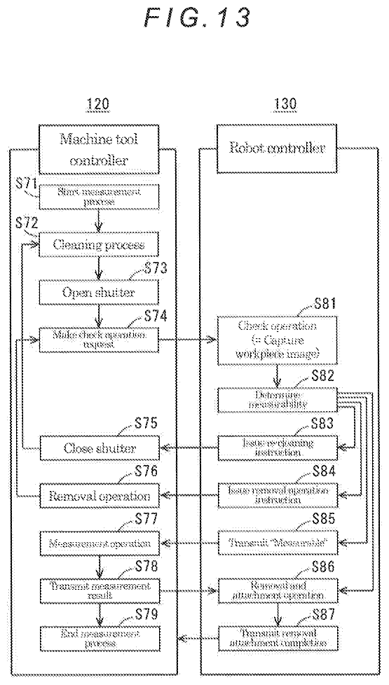

Also in this embodiment, the robot 130 executes the workpiece removal and attachment operation including the image capture step and the determination step in response to a request from the machine tool 120. The process procedure shown in FIG. 13 is executed in this embodiment. The processes in FIG. 13 are executed in the controller of the machine tool 120 and the controller of the robot 130; however, in the following description, for the sake of simplicity, the machine tool 120 inclusive of the controller thereof is simply referred to as the machine tool 120 and the robot 130 inclusive of the controller thereof is simply referred to as the robot 130.

Upon completing machining of a workpiece W, the machine tool 120 starts the measurement process (step S71). The machine tool 120 executes the cleaning process (step S72), then opens the shutter (step S73), and then makes a request (transmits an execution signal) to the robot 130 to execute a check operation (step S74). Upon receiving the request, the robot 130 executes the check operation (step S81). Specifically, the robot 130 enters the machining area through the opening of the partition member 151, then shifts to a pose for capturing an image of the portion to be measured of the workpiece W with the camera 132, and then captures an image of the workpiece W with the camera 132 (image capture step).

Subsequently, the robot 130 analyzes the captured image and determines, in the same manner as described above, whether or not a chip is present on the path along which the touch probe 110 is to be moved, in other words, whether or not the workpiece W is measurable (step S82) (determination step).

When the evaluation result is the “Re-cleaning required” state, the robot 130 subsequently instructs the machine tool 120 to execute the re-cleaning process (step S83) and then returns to the standby position outside the machining area through the opening of the partition member 151. When the evaluation result is the “Removal required” state, the robot 130 subsequently instructs the machine tool 120 to execute the removal operation (step S84) and then retracts to an appropriate position inside the machining area. When the evaluation result is the “Measurable” state, the robot 130 transmits a “Measurable” signal to the machine tool 120 (step S85). When the evaluation result is the “Unmeasurable” state that indicates that the presence of a chip is still observed on the movement path even after the re-cleaning process or the removal operation is executed, the robot 130 removes the workpiece W from the chuck 123 of the machine tool 120 and transports and stores the workpiece W into the pending product stocker 148. Subsequently, the robot 130 takes out a new material from the material stocker 146 and transports the material to the chuck 123 of the machine tool 120 to cause the material to be clamped by the chuck 123 (step S86). Thereafter, the robot 130 returns to the standby position outside the machining area and transmits the removal and attachment completion signal to the machine tool 120 (step S87).

Upon receiving the re-cleaning instruction from the robot 130, the machine tool 120 closes the shutter (step S75) and re-executes the above-described cleaning process (step S73), and then performs the operations in the step S74 and subsequent steps. Upon receiving the removal instruction from the robot 130, the machine tool 120 executes the same removal operation as in the step S7 described above (step S76), and then re-performs the operation in the step S74.

Upon receiving the “Measurable” signal from the robot 130, the machine tool 120 executes the above-described measurement operation using the touch probe 110 (step S77). Thereafter, the machine tool 120 transmits the measurement result to the robot 130 (step S78) and ends the measurement process (step S79).

After receiving the measurement result from the machine tool 120, the robot 130 removes the workpiece W from the chuck 123 of the machine tool 120. When the workpiece W is a non-defective product, the robot 130 transports and stores the workpiece W into the product stocker 147. When the workpiece W is a defective product, the robot 130 transports and stores the workpiece W into the pending product stocker 148. Subsequently, the robot 130 takes out a new material from the material stocker 146 and transports the material to the chuck 123 of the machine tool 120 to cause the material to be clamped by the chuck 123 (step S86). Thereafter, the robot 130 returns to the standby position outside the machining area and transmits the removal and attachment completion signal to the machine tool 120 (step S87).

Upon receiving the removal and attachment completion signal transmitted from the robot 130 in the operation in the step S87, the machine tool 120 machines the next workpiece. Upon completing the machining, the machine tool 120 executes the measurement process, that is to say, performs the operations in the step S71 and subsequent steps.

Thus, the method according to this embodiment is also configured such that: an image of the portion to be measured of the machined workpiece W is captured with the camera 132 that is provided on the robot 130; the captured image is analyzed and it is thereby determined whether or not a chip is present on the movement path of the touch probe 110; and the dimension measurement of the workpiece W using the touch probe 110 is executed only when it is determined that no chip is present on the movement path. Therefore, the dimension of the workpiece W is accurately measured and the touch probe 110 is reliably prevented from being damaged by coming into contact with a chip.

Further, when it is determined in the determination step at the step S82 that a chip is present on the movement path of the touch probe 110, the machine tool 120 executes the removal step of removing the chip present on the movement path, that is to say, executes the re-cleaning process (step S72) or the removal operation (step S76). This prevents the workpiece W from being determined to be unmeasurable and classified as a pending product in a single check operation (determination process), so that high-yield measurement is realized.

### Variation of Third Embodiment

The robot 130 in the above-described third embodiment is attached to the outer side of the machine tool 120. However, the present invention is not limited thereto. For example, in the structure illustrated in FIG. 12, the robot 130 may be disposed on the headstock 122 side, for example, may be disposed above the headstock 122. In this case, the carriage 141, the beam 142, the supports 143, 143, the placement table 145, the material stocker 146, the product stocker 147, the pending product stocker 148, etc. are omitted.

Also in this configuration, the robot 130 executes the workpiece removal and attachment operation including the image capture step and the determination step in response to a request from the machine tool 120. However, the steps S73 and S75 of the procedure shown in FIG. 13 are omitted.

### Fourth Embodiment

Next, a fourth embodiment of the present invention is described. In the above-described embodiments, the image capture step and the determination step are executed by the robot 25, 130. However, the present invention is not limited thereto. In the third embodiment illustrated in FIG. 12, the elements associated with the robot 130, i.e., the robot 130, the carriage 141, the beam 142, the supports 143, 143, the placement table 145, the material stocker 146, the product stocker 147, the pending product stocker 148, and other associated elements, can be omitted by mounting the camera 132 on a movable body, such as, the turret 128 or the tool spindle 126, of the machine tool 120 so as to execute the image capture step and the determination step. Note that the movable body is not limited to the turret 128 and the tool spindle 126 and can be any appropriate movable body provided in the machine tool 120.

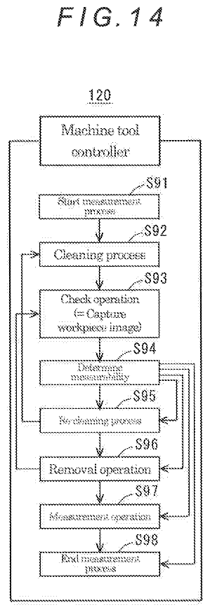

In this case, the measurement process is executed in accordance with the procedure shown in FIG. 14 by the controller of the machine tool 120. In the following description, for the sake of simplicity, the machine tool 120 inclusive of the controller thereof is simply referred to as the machine tool 120.

That is to say, upon completing machining of a workpiece W, the machine tool 120 starts the measurement process (step S91). The machine tool 120 executes the cleaning process (step S92) and then executes a check operation (transmits an execution signal to a processing unit) (step S93). Specifically, the machine tool 120 appropriately moves the movable body on which the camera 132 is mounted, and captures an image of the portion to be measured of the workpiece W with the camera 132 (image capture step).

Subsequently, the machine tool 120 analyzes the captured image and determines whether or not a chip is present on the movement path along which the touch probe 110 is to be moved. That is to say, the machine tool 120 transmits a process start signal (execution signal) to the processing unit to cause the processing unit to execute the same processing as in the above-described embodiments, thereby determining whether or not the workpiece W is measurable (step S94) (determination step).

When the evaluation result is the “Re-cleaning required” state, the machine tool 120 subsequently executes the re-cleaning process (step S95), i.e., performs the operations in the step S92 and subsequent steps. When the evaluation result is the “Removal required” state, the machine tool 120 subsequently executes the same removal operation as in the above-described embodiments (step S96), and then performs the operations in the step S93 and subsequent steps. When the evaluation result is the “Measurable” state, the machine tool 120 executes the measurement operation (step S97) and then ends the measurement process (step S98).

When the result in the measurability determination (step S94) after the execution of the re-cleaning process or the removal operation is the “Unmeasurable” state that indicates that the presence of a chip is still observed on the movement path even after the re-cleaning process or the removal operation is executed, the machine tool 120 halts the measurement and ends the measurement process (step S98).

Thus, the method according to this embodiment is also configured such that: an image of the portion to be measured of the machined workpiece W is captured with the camera 132; the captured image is analyzed and it is thereby determined whether or not a chip is present on the movement path of the touch probe 110; and the dimension measurement of the workpiece W using the touch probe 110 is executed only when it is determined that no chip is present on the movement path. Therefore, the dimension of the workpiece W is accurately measured and the touch probe 110 is reliably prevented from being damaged by coming into contact with a chip.

Further, when it is determined in the determination step at the step S94 that a chip is present on the movement path of the touch probe 110, the machine tool 120 executes the removal step of removing the chip present on the movement path, that is to say, executes the re-cleaning process (step S95, S92) or the removal operation (step S96). This prevents the workpiece W from being determined to be unmeasurable and classified as a pending product in a single check operation (determination process), so that high-yield measurement is realized.

Above have been described specific embodiments of the present invention. However, it should be noted that the foregoing description of the embodiments is not limitative but illustrative in all aspects. One skilled in the art would be able to make variations and modifications as appropriate. The scope of the invention is not defined by the above-described embodiments, but is defined by the appended claims. Further, the scope of the invention encompasses all modifications made from the embodiments within a scope equivalent to the scope of the claims.

### REFERENCE SIGNS LIST

1 Production system
10 Management device
20 Automatic working device
25 Robot
30 Camera
35 Automated guided vehicle
100 Machine tool
110 Touch probe
111 Removal tool
120 Material stocker
121 Product stocker
122 Pending product stocker
C Chip
W Workpiece

What is claimed is:

1. A method for measurement of a workpiece machined by a machine tool, wherein the measurement of the workpiece is executed using a measurement device including a probe and the measurement of the workpiece is executed by moving the probe into contact with the workpiece in a state where the workpiece is held by the machine tool,
the method including:
an image capture step of capturing an image of a portion to be measured of the workpiece with a camera; and
a determination step of processing the image captured with the camera and determining whether or not a chip is present on a movement path along which the probe is to be moved,
wherein the measurement of the workpiece using the probe is executed when no chip is present on the movement path of the probe in the determination step.

2. The method according to claim 1, wherein:
the method further includes a removal step of, when a chip is present on the movement path of the probe in the determination step, removing the chip from the movement path;
the image capture step and the determination step are re-executed after the removal step is executed;
when no chip is present on the movement path of the probe in the re-executed determination step, dimension measurement of the workpiece using the probe is executed; and
when a chip is present on the movement path of the probe in the re-executed determination step, the measurement of the workpiece using the probe is halted.

3. The method according to claim 1, wherein, in the image capture step, a camera provided on a movable body of the machine tool is used and the camera is moved to an image capture position by the movable body to capture an image of the portion to be measured of the workpiece.

4. The method according to claim 2, wherein, in the image capture step, a camera provided on a movable body of the machine tool is used and the camera is moved to an image capture position by the movable body to capture an image of the portion to be measured of the workpiece.

5. The method according to claim 1, wherein, in the image capture step, a camera provided on a manipulator configured to attach and remove the workpiece to and from a workpiece holding unit of the machine tool is used and the camera is moved to an image capture position by operation of the manipulator to capture an image of the portion to be measured of the workpiece.

6. The method according to claim 2, wherein, in the image capture step, a camera provided on a manipulator configured to attach and remove the workpiece to and from a workpiece holding unit of the machine tool is used and the camera is moved to an image capture position by operation of the manipulator to capture an image of the portion to be measured of the workpiece.

7. The method according to claim 5, wherein the manipulator is provided to be capable of autonomously traveling.

8. The method according to claim 6, wherein the manipulator is provided to be capable of autonomously traveling.

9. The method according to claim 1, wherein:
the method further includes:
a step of moving an automatic working device to a working position set with respect to the machine tool, wherein the automatic working device includes a camera and is configured to perform work on the machine tool and the automatic working device is moved to the working position by issuing an instruction to the automatic working device from the machine tool or a management device managing the automatic working device; and
a cleaning step of cleaning the workpiece machined by the machine tool, wherein the workpiece is cleaned in the machine tool in the state where the workpiece is held by the machine tool;
in the image capture step, an image of the portion to be measured of the workpiece cleaned in the cleaning step is captured with the camera of the automatic working device by issuing an instruction to the automatic working device from the machine tool; and
in the determination step, the image captured with the camera is processed in the management device or the automatic working device and it is determined whether or not a chip is present on the movement path along which the probe is to be moved.

10. A machine tool for machining a workpiece, the machine tool including a controller and being capable of, under control by the controller, measuring the workpiece after machining by moving a probe into contact with the workpiece while holding the workpiece, wherein
the controller is configured to:
capture an image of a portion to be measured of the workpiece after machining with a camera provided on the machine tool by operating the camera, and issue an instruction for execution of a process of processing the captured image and determining whether or not a chip is present on a movement path along which the probe is to be moved; or
cause a camera provided on an external device to capture an image of the portion to be measured of the workpiece after machining, and issue an instruction for execution of a process of processing the captured image and determining whether or not a chip is present on the movement path along which the probe is to be moved; and
when no chip is present on the movement path of the probe, measure the workpiece by moving the probe.
